(19) United States
(12) Patent Application Publication
(10) Pub. No.: US 2021/0011835 A1
(43) Pub. Date: Jan. 14, 2021

(54) SYSTEM AND METHOD FOR DEBUGGING SOURCE CODE OF AN APPLICATION

(71) Applicant: HCL America Inc., Sunnyvale, CA (US)

(72) Inventors: Cesar Ivan Orozco Cervantes, Jalisco (MX); Heath Thomann, Cary, NC (US); Michael James Hudson, Boca Raton, FL (US)

(21) Appl. No.: 16/509,823

(22) Filed: Jul. 12, 2019

(51) Int. Cl. G06F 11/36

(52) U.S. Cl. CPC G06F 11/3624

(57) ABSTRACT

Disclosed is a method and system for debugging source code of an application. The method includes establishing a WebSocket connection with a Chrome DevTools Protocol, using a unique Uniform Resource Locator (URL) created by Node.js. The Chrome DevTools Protocol is a V8 inspector. The method further includes listening for asynchronous messages from the V8 inspector. The asynchronous messages are defined by V8 inspector protocol. Responses received from the V8 inspector protocol are processed and debugger operations selected by a user are translated into operations known to the V8 inspector. The source code of the application is executed on the Node.js utilizing launch configuration and data required for starting a Node.js process with responsibilities of terminating the Node.js process when the user ends the debug session.

### CROSS-REFERENCE TO RELATED APPLICATIONS AND PRIORITY

The present application does not claim priority from any patent application.

### TECHNICAL FIELD

The present subject matter described herein, in general, relates to debugging of source codes.

### BACKGROUND

In Node.js version 6.3.0, Node.js developers changed the debug options used to start Node.js in debug mode. More problematically, they also changed the protocol used to communicate with Node.js in debug mode. With these changes, any debugger client that uses the old debug settings and protocol would be broken. One such client is Eclipse and its JavaScript Development Tools (JSDT) debugger client in the JSDT project. For example, while using Node.js version 8, the below provided warning could be seen in the Eclipse console when attempting to debug a Node.js application in Eclipse: “(node:2980) [DEP0062] Deprecation Warning: ‘node --debug’ and ‘node --debug-brk’ are invalid. Please use ‘node --inspect’ or ‘node --inspect-brk’ instead.”

Other tools such as Nodeclipe/Enide are also broken. Nodeclipe even announced that its debugger is broken and needs help fixing it. This can be seen by this announcement on nodecipse.org:“2018-01-11 Nodejs 8 has depricated --debug command option, so debug may not work. The code in question is cmdLine.add(“--debug”+brk+“=”+nodeDebugPort); LaunchConfigurationDelegatejava#L114. Help is needed to try out solution for Nodejs 8 #220.” IBM at around the same time removed its Node.js debugger and tools. Another notable tool VJet JavaScript IDE has also deprecated its set of JS/debugger tools. Given all of this, there is a gap in Eclipse tools, and others, for a modern Node.js debugger.

A user usually develops Node.js applications and JavaScript code within an Integrated Development Environment (IDE), such as Eclipse. However, to debug the applications, currently a user needs to exit the Eclipse IDE and use an external debugger, as well as manually start the Node.js process in debug mode. This is cumbersome for a user as it requires to go back and forth between three environments, as well as possibly installing additional software. Therefore, there remains a need of a debugger that allows a user to debug Node.js applications within their existing Eclipse environment.

### SUMMARY

Before the present systems and methods for debugging source code of an application are described, it is to be understood that this application is not limited to the particular systems, and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application.

This summary is provided to introduce aspects related to a system and a method for debugging source code of an application. This summary is not intended to identify essential features of the claimed subject matter nor is it intended for use in determining or limiting the scope of the claimed subject matter.

In one implementation, a system for debugging source code of an application is disclosed. In one aspect, the system comprises a memory and a processor coupled to the memory. Further, the processor may be capable of executing instructions in the memory to perform one or more steps. In the aspect, the system may establish a WebSocket connection with a Chrome DevTools Protocol, using a unique Uniform Resource Locator (URL) created by Node.js. The Chrome DevTools Protocol is a V8 inspector. The system may further listen for asynchronous messages from the V8 inspector. The asynchronous messages may be defined by V8 inspector protocol. The system may further process responses received from the V8 inspector protocol and translate debugger operations selected by a user into operations known to the V8 inspector. The system may further execute the source code of the application on the Node.js utilizing launch configuration and data required for starting a Node.js process with responsibilities of terminating the Node.js process when the user ends the debug session.

In one implementation, a method for debugging source code of an application is disclosed. In one aspect, the method may comprise establishing, by a WebSocket client, a WebSocket connection with a Chrome DevTools Protocol, using a unique Uniform Resource Locator (URL) created by Node.js. The Chrome DevTools Protocol is a V8 inspector. The method may further comprise listening, by the WebSocket client, for asynchronous messages from the V8 inspector. The asynchronous messages may be defined by V8 inspector protocol. The method may further comprise processing, by a second client connected to the WebSocket client, responses received from the V8 inspector protocol and translating debugger operations selected by a user into operations known to the V8 inspector. The method may further comprise executing the source code of the application on the Node.js utilizing launch configuration and data required for starting a Node.js process with responsibilities of terminating the Node.js process when the user ends the debug session.

In yet another implementation, non-transitory computer readable medium embodying a program executable in a computing device for debugging source code of an application is disclosed. In one aspect, the program may comprise a program code for establishing a WebSocket connection with a Chrome DevTools Protocol, using a unique Uniform Resource Locator (URL) created by Node.js. The Chrome DevTools Protocol is a V8 inspector. The program may further comprise a program code for listening for asynchronous messages from the V8 inspector. The asynchronous messages may be defined by V8 inspector protocol. The program may further comprise a program code for processing responses received from the V8 inspector protocol and translating debugger operations selected by a user into operations known to the V8 inspector. The program may further comprise a program code for executing the source code of the application on the Node.js utilizing launch configuration and data required for starting a Node.js process with responsibilities of terminating the Node.js process when the user ends the debug session.

### BRIEF DESCRIPTION OF THE DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system disclosed in the document and the figures.

The present subject matter is described in detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network architecture diagram 100 of a system 102 for debugging source code of an application, in accordance with an embodiment of the present subject matter.

FIG. 2 illustrates a block level diagram of the system 102, in accordance with an embodiment of the present subject matter.

FIG. 3 illustrates a block level diagram 300 showing components of Node.js runtime 302 and Eclipse IDE/framework 304, in accordance with an embodiment of the present subject matter.

FIG. 4 illustrates a method 400 for debugging source code of an application in a real time by a user, in accordance with an embodiment of the present subject matter.

FIG. 5 illustrates a method 500 for debugging source code of an application with hot swap/live edit methodology, in accordance with an embodiment of the present subject matter.

FIG. 6 illustrates a method 600 for debugging source code of an application with processing of stack and variable data, in accordance with an embodiment of the present subject matter.

FIG. 7 illustrates a method 700 for debugging JavaScript source code of an application, in accordance with an embodiment of the present subject matter.

FIG. 8 illustrates a method 800 for debugging source code of an application, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods for debugging source code of an application, similar or equivalent to those described herein can be used in the practice or testing of embodiments of the present disclosure, the exemplary, systems and methods for debugging source code of an application are now described. The disclosed embodiments for debugging source code of an application are merely examples of the disclosure, which may be embodied in various forms.

Various modifications to the embodiment will be readily apparent to those skilled in the art and the generic principles herein may be applied to other embodiments for debugging source code of an application. However, one of ordinary skill in the art will readily recognize that the present disclosure for debugging source code of an application is not intended to be limited to the embodiments described, but is to be accorded the widest scope consistent with the principles and features described herein.

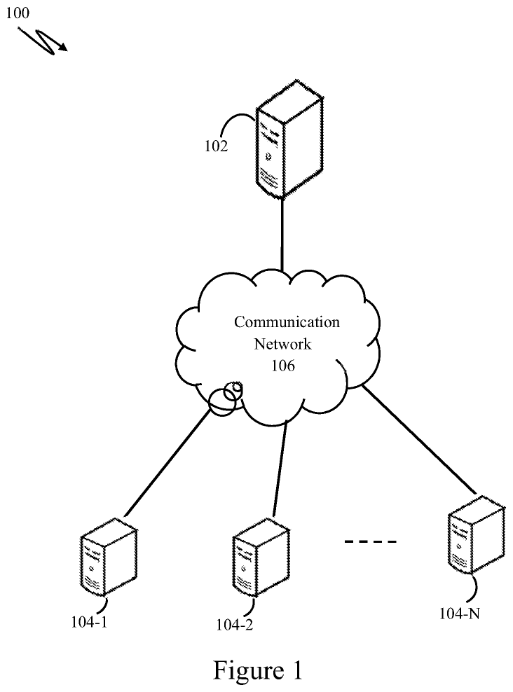

Referring now to FIG. 1, a network implementation diagram 100 of a system 102 for debugging source code of an application, in accordance with an embodiment of the present subject matter may be described. In one example, the system 102 may be connected with several other devices 104-1 through 104-N (collectively referred as 104) through a communication network 106.

It should be understood that the system 102 and the devices 104 are different computing devices used by different users. t may be understood that the system 102 and the devices 104 may also be implemented in a variety of computing systems, such as a laptop computer, a desktop computer, a notebook, a workstation, a mainframe computer, a server, a network server, a cloud-based computing environment, or a mobile and the like. It may also be understood that the system 102 supports a plurality of browsers and all viewports. Examples of the plurality of browsers may include, but not limited to, Chrome™, Mozilla™ Internet Explorer™, Safari™, and Opera™.

In one implementation, the communication network 106 may be a wireless network, a wired network, or a combination thereof. The communication network 106 can be implemented as one of the different types of networks, such as intranet, Local Area Network (LAN), Wireless Personal Area Network (WPAN), Wireless Local Area Network (WLAN), wide area network (WAN), the internet, and the like. The communication network 104 may either be a dedicated network or a shared network. The shared network represents an association of the different types of networks that use a variety of protocols, for example, MQ Telemetry Transport (MQTT), Extensible Messaging and Presence Protocol (XMPP), Hypertext Transfer Protocol (HTTP), Transmission Control Protocol/Internet Protocol (TCP/IP), Wireless Application Protocol (WAP), and the like, to communicate with one another. Further, the communication network 106 may include a variety of network devices, including routers, bridges, servers, computing devices, storage devices, and the like.

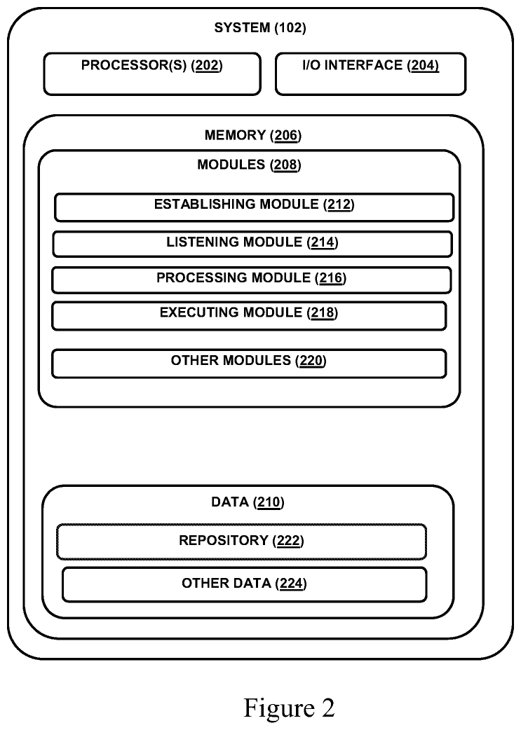

Referring now to FIG. 2, a block diagram 200 of the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow a user to interact with the system 102. Further, the I/O interface 204 may enable the system 102 to communicate with the user devices 104, and other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206, amongst other things, serves as a repository for storing data processed, received, and generated by one or more of modules 208. The memory 206 may include any computer-readable medium or computer program product known in the art including, for example, volatile memory, such as Static Random Access Memory (SRAM) and Dynamic Random Access Memory (DRAM), and/or non-volatile memory, such as Read Only Memory (ROM), Erasable Programmable ROM (EPROM), Electrically Erasable and Programmable ROM (EEPROM), flash memories, hard disks, optical disks, and magnetic tapes.

The memory 206 may include data generated as a result of the execution of one or more of the modules 208. In one implementation, the memory 206 may include data 210. The modules 208 include routines, programs, objects, components, data structures, etc., which perform particular tasks or implement particular abstract data types. In one implementation, the modules 208 may include an establishing module 212, a listening module 214, a processing module 216, an executing module 218, and other modules 220. The other modules 220 may include programs or coded instructions that supplement applications and functions of the system 102. The modules 208 described herein may be implemented as software modules that may be executed in the cloud-based computing environment of the system 102.

The data 210 may include a repository 222 for storing data processed, computed, received, and generated by one or more of the modules 208. Furthermore, the data 210 may include other data 224 for storing data generated as a result of the execution of one or more modules in the other modules 220.

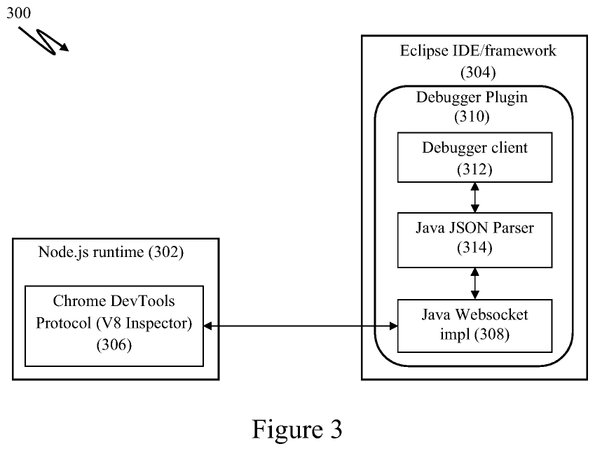

Referring to FIG. 3, a block level diagram 300 showing components of Node.js runtime 302 and Eclipse IDE/framework 304 is illustrated. The Node.js runtime 302 includes a chrome DevTools protocol i.e. V8 Inspector 306, and communicates with a Java Websocket implementer 308 that is a part of a Debugger plugin 310 of the Eclipse IDE/framework 304. The Debugger plugin 310 also includes a Debugger client 312 and a Java JSON Parser 314.

In one implementation, at first, a WebSocket client with an establishing module 212 may establish a WebSocket connection with a Chrome DevTools Protocol. The Chrome DevTools Protocol is also identified as a V8 inspector. Further, the WebSocket connection may be established using a unique Uniform Resource Locator (URL) created by Node.js upon initialization. The WebSocket client through the listening module 214 may listen for asynchronous messages from the V8 Inspector. The asynchronous messages may be defined by V8 Inspector protocol. Given the asynchronous nature of WebSocket communication, the WebSocket client through the processing module 216 may process received messages as quickly as possible and may return responses to the received messages, so as not to block other incoming messages.

Thereafter, a second client connected to the WebSocket client may process responses received from the V8 inspector protocol. The second client may also send necessary commands, such as Debugger.setBreakpoint and Debugger.step. The messages may be defined on the V8 Inspector protocol and may consist of ‘methods’ and ‘events’. A ‘method’ includes commands such as debugger pause, stepping, resuming, termination, etc. In addition, the second client may handle operations performed by the user on a Graphical User Interface (GUI) of Eclipse debugger framework, such as resuming from a breakpoint pause, or stepping into, out of, or over the current line of code. Further, the second client may translate debugger operations selected by a user into operations known to the V8 inspector. For example, the second client may receive notification of an Eclipse ‘step’ button operation by the user, and may translate the notification into a corresponding operation known to the V8 inspector as a ‘step’ method.

In one embodiment, the source code of the application may be executed on the Node.js for debugging, by the executing module 218. In one case, source code of a JavaScript application may be debugged. The source code may be executed using a run and debug launch command or as a part of Eclipse run/debug configuration. The source code of the application may be executed utilizing launch configuration and data required for starting a Node.js process with responsibilities of terminating the Node.js process when the user ends the debug session.

In one embodiment, debugging on the Node.js may be allowed under one of inspect and inspect-brk mode. As a part of the launch configuration, the user can select between these two options when creating the configuration. A run and debug launcher will extract from the configuration and use the one selected and start the Node.js process accordingly. Because the V8 Inspector handles these two modes differently, and more importantly the command/messages it sends in response to these two modes, the mechanism itself will always use the --inspect-brk option, and provide runtime behavior fitting for each option, thus allowing the user to receive the experience expected for the selection made.

In one embodiment, using the run and debug launcher, a user may define the script that he would like to run or debug. Further, the user may also select various other options that are unique only to a debug command, such as Node.js debug options, application options, and host and port details. The run and debug launcher may attempt to reuse a configuration should one exist for a script selected for debugging by the user, alternatively the run and debug launcher may create a new configuration.

In one embodiment, a program code may be present to process breakpoints set on a Node.js application i.e. the script. A mechanism to translate a breakpoint set on a script within the Eclipse JavaScript editor into a ‘setBreakpoint’ method may be sent to the V8 Inspector. The V8 Inspector expects a ‘setBreakpoint’ method to include a line number where the user has set the breakpoint on the script, as well as a URL location of the script. Such program code may create a URL that operates system agnostic. Further, such mechanism may utilize the WebSocket client to send the ‘setBreakpoint’ method as well as to receive results of the method.

In one embodiment, a sequence of keys may be provided as a shortcut in Eclipse to launch debugging of the source code of the JavaScript application. Such shortcut may execute a currently selected script. In case a project is selected, a relevant project directory structure is identified for the script that a user has defined as the ‘main’ script file. Should one project directory structure not exist, the launch configuration that needs to be described will be presented to the user.

In one embodiment, a mechanism to hot swap source script may be provided. As an application is being debugged, source code of the application is executed on the Node.js. Typically, the source code is static which means that once executing, the source code doesn't change, and the source code is not updated. Updating the source code would typically require stopping the Node.js process, changing and deploying the source code, and then restarting the Node.js process. However, such tedious process is avoided by hot swapping the source script. By hot swapping the source script, a user can make changes to a source script while being debugged, and the changes may be automatically reflected in runtime. Thus, hot swapping the source script would allow a user to debug updates to the source code in real-time.

In one embodiment, a stack view may be provided to the user. The stack view may show current stack of execution in the Node.js process, one or more scripts being executed, current function being executed, and a line number of execution within a script. The user may click on any entry i.e. a stack frame present within the stack view to show current execution state (variables/values) within a selected script.

In one embodiment, a variable view may be provided in the Eclipse Debugger Framework that may show a current state (variable/value) of a script selected by the user. A variable may have a single (primitive) value, or may consist of a deep set of other variable/value pairs where the variable may be expandable to many levels. The variable view may allow the user to change value of a variable while the value is defined to be editable. The variable view will use the WebSocket client to retrieve, from the V8 Inspector, current Node.js execution state.

JavaScript defines ‘accessor’ methods on an Object property. Such methods are accessible via application code as well as a debugger client. Current embodiments of the disclosure provide a mechanism to invoke an accessor method on demand rather than automatically invoking the accessor when a corresponding Object is loaded. This allows a user of the debugger to invoke the accessor as and when required, rather than having every accessor method called automatically.

In one embodiment, a source locator may be provided to allow the Eclipse Debugger Framework to locate the source code of a file being debugged on the Node.js. When the user selects a stack frame (script) within the stack view, the Eclipse Debugger Framework may need to be provided with source code corresponding to a selected script. Therefore, the source locator may locate and may pass a selected script file's source to the Eclipse Debugger Framework.

Exemplary embodiments for debugging source code of an application, as discussed above, may provide certain advantages. Though not required to practice aspects of the disclosure, these advantages may include those provided by the following features.

Some embodiments of the system and the method allow debugging Node.js application within the Eclipse IDE environment.

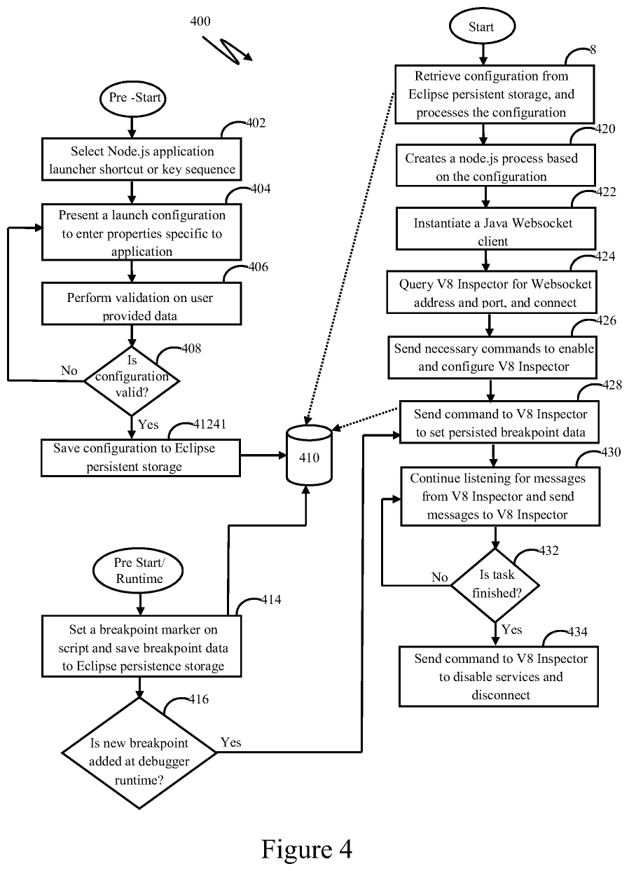

Referring now to FIG. 4, a method 400 for debugging source code of an application in a real time by a user is described, in accordance with an embodiment of the present subject matter. The method 400 includes pre-start or runtime executions. A runtime execution includes selection of a Node.js application launcher or a Node.js application launcher shortcut key sequence, by a user, at step 402. Further, a launch configuration dialog may be presented to the user to enter properties specific to an application, at step 404. Validation may be performed on user provided data, by a debugger, at step 406. The user provided data may include hostname, port, script file, Node.js arguments, and program argument. Successively, validity of the configuration may be checked, at step 408. Control may be transferred to step 404 while the configuration is identified to be invalid. Alternatively, configuration may be saved to Eclipse persistent storage 410 by the debugger, at step 412, while the configuration is identified to be valid. Another runtime execution includes setting a breakpoint marker on a script, by the user, in Eclipse JavaScript editor, at step 414. Debugger client may save breakpoint data to the Eclipse persistent storage 410. Successively, it may be determined at step 416 if a new breakpoint is added at debugger runtime. Control may be transferred at step 428 while a new breakpoint is found to be added at a debugger runtime.

Successive to the runtime executions, configuration may be retrieved from the Eclipse persistent storage 410 by the debugger client and the configuration may be processed, at step 418. Further, the debugger client may create a default configuration while no configurations are found to exist, at step 418. A Node.js process may be created based on the configuration, by the debugger, at step 420. The Node.js process may be started in a debug mode with “break on start” i.e. inspect-brk, but may handle (at runtime) a case while the user wants “inspect” to be used. A Java WebSocket client may thereafter be instantiated, at step 422. The WebSocket client may query the V8 Inspector for WebSocket address and port, at step 424. Using the retrieved WebSocket address and port, the WebSocket client may connect to the V8 Inspector. The WebSocket client may send necessary commands to enable and configure the V8 Inspector, at step 426. Thereafter, command may be sent to the V8 Inspector to set persisted breakpoint data, at step 428. The WebSocket client may continue listening for messages from the V8 Inspector and may send the messages, received from the debugger client, to the V8 Inspector, at step 430. At step 432, it may be determined if the task is finished. Control may remain present at step 430 till the task is finished. After the task is finished, the WebSocket client may send a command to the V8 Inspector to disable services and to disconnect, at step 434.

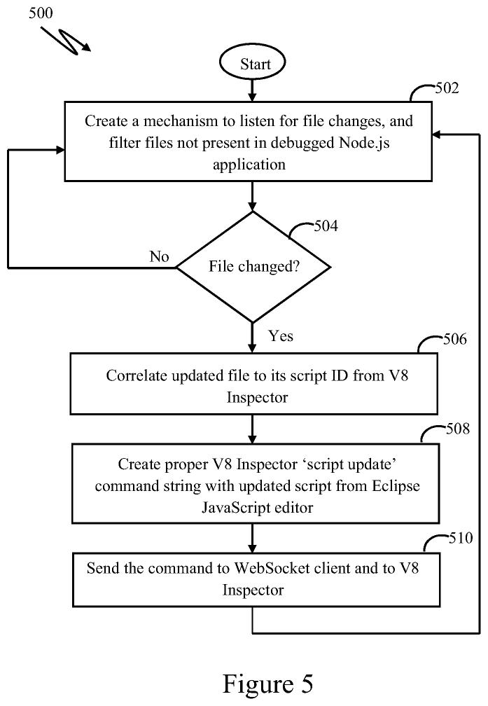

Referring now to FIG. 5, a method 500 for debugging source code of an application with hot swap/live edit methodology is explained, in accordance with an embodiment of the present subject matter. A mechanism to listen for file changes may be created by the debugger, at step 502. Further, files not contained in debugged node.js application may be filtered out. At step 504, it may be determined if the file has changed. Control may be transferred back to step 502 while the file has not changed. Alternatively, while the file has changed, updated file may be correlated to its script ID from V8 Inspector, at step 506. A proper V8 Inspector ‘script update’ method/command may be created with updated script from Eclipse JavaScript editor, at step 508. The method/command may be sent to the WebSocket client, at step 510. Further, the WebSocket client may send the command to the V8 Inspector.

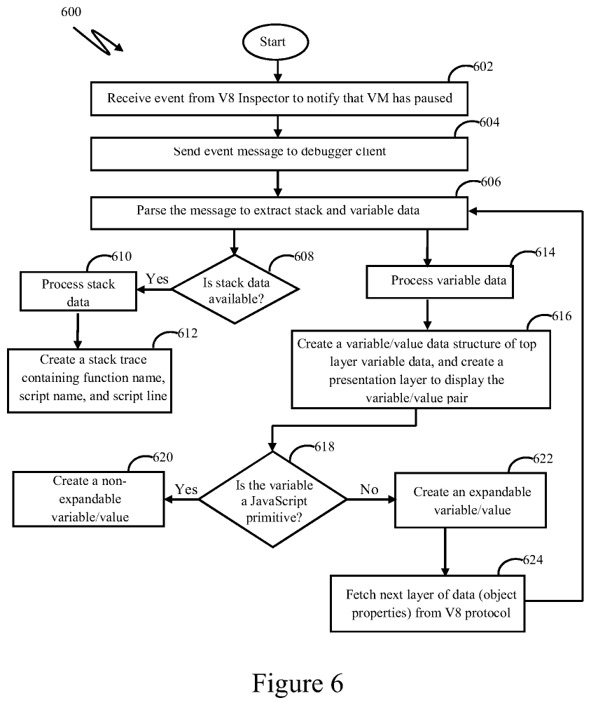

Referring now to FIG. 6, a method 600 for debugging source code of an application with processing of stack and variable data is explained, in accordance with an embodiment of the present subject matter. The method 600 includes receiving an event from the V8 Inspector to notify that VM has paused (e.g. breakpoint hit, and step), at step 602. An event message may include execution content of paused VM. The WebSocket client may send an event message to the debugger client, at step 604. The debugger client may parse the message to extract stack and variable data, at step 606. At step 608, it may be determined if stack data is available. In case stack data is found to be available, stack data may be processed, at step 610. Thereupon, a stack trace may be created by the debugger, at step 612. The stack trace may include function name, script name, and script line number. The stack may be made presentable via Eclipse stack view.

Alternate to availability of stack data, variable data may be processed, at step 614. During processing of the variable data, a variable/value data structure of top layer variable data may be created. This may delay loading of next level of data and may create a presentation layer (Eclipse view) to display variable/value pair, at step 616. Thereafter, it may be determined if the variable is a JavaScript primitive, at step 618. In case the variable is identified to be a JavaScript primitive, a non-expandable variable/value may be created, and data may be fully loaded, at step 620. Alternatively, if the variable isn't identified to be a JavaScript primitive, an expandable variable/value may be created, at step 622. At this stage, data may not be fully loaded, thus allowing for data to be loaded on demand upon user triggered variable expansion. The WebSocket client may fetch next layer of data (object properties) from the V8 protocol, at step 624.

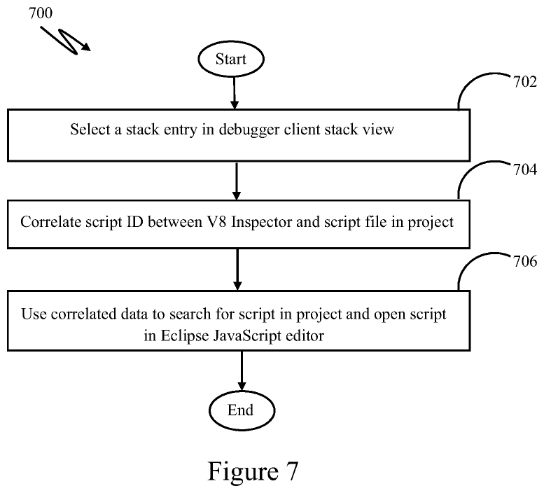

Referring now to FIG. 7, a method 700 for debugging JavaScript source code of an application is explained, in accordance with an embodiment of the present subject matter. The method 700 includes selection of a stack entry in debugger client stack view by a user, at step 702. Stack fame can be associated with a script file in the project. Stack data from the V8 Inspector may contain a ‘script ID.’ The WebSocket client may correlate the script ID between the V8 Inspector and the script file in the project, at step 704. The debugger client may use correlated data to search for the script in the project and may open the script in the Eclipse JavaScript editor, at step 706.

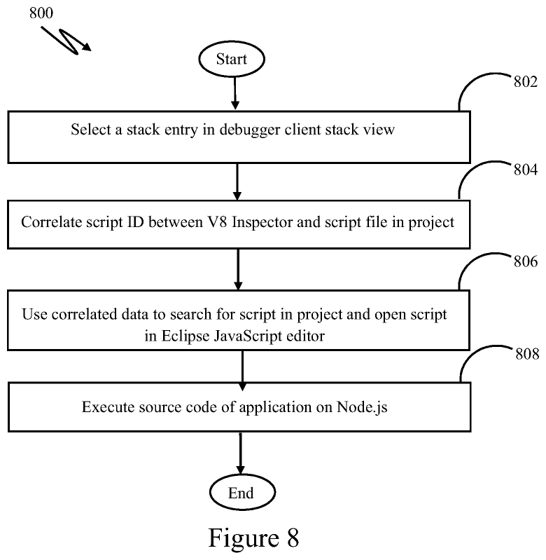

Referring now to FIG. 8, a method 800 for debugging source code of an application is described, in accordance with an embodiment of the present subject matter. The method 800 may be described in the general context of computer executable instructions. Generally, computer executable instructions can include routines, programs, objects, components, data structures, procedures, modules, functions, etc., that perform particular functions or implement particular abstract data types.

The order in which the method 800 for debugging source code of an application is described is not intended to be construed as a limitation, and any number of the described method blocks can be combined in any order to implement the method 800 or alternate methods. Additionally, individual blocks may be deleted from the method 800 without departing from the spirit and scope of the subject matter described herein. Furthermore, the method can be implemented in any suitable hardware, software, firmware, or combination thereof. However, for ease of explanation, in the embodiments described below, the method 800 may be considered to be implemented in the above described system 102.

At block 802, a WebSocket connection may be established with a Chrome DevTools Protocol by a WebSocket client, using a unique Uniform Resource Locator (URL) created by Node.js. The Chrome DevTools Protocol is also identified as a V8 inspector.

At block 804, the WebSocket client may listen for asynchronous messages from the V8 inspector. The asynchronous messages may be defined by V8 inspector protocol.

At block 806, responses received from the V8 inspector protocol may be processed by a second client connected to the WebSocket client. Further, debugger operations selected by a user may be translated into operations known to the V8 inspector.

At block 808, the source code of the application may be executed on the Node.js utilizing launch configuration and data required for starting a Node.js process with responsibilities of terminating the Node.js process when the user ends the debug session.

Although implementations for methods and systems for debugging source code of an application have been described in language specific to structural features and/or methods, it is to be understood that the appended claims are not necessarily limited to the specific features or methods described. Rather, the specific features and methods are disclosed as examples of implementations for debugging source code of an application.

1. A method for debugging source code of an application, the method comprising:
establishing, by a WebSocket client, a WebSocket connection with a Chrome DevTools Protocol, using a unique Uniform Resource Locator (URL) created by Node.js, wherein the Chrome DevTools Protocol is a V8 inspector;
listening, by the WebSocket client, for asynchronous messages from the V8 inspector, wherein the asynchronous messages are defined by a V8 inspector protocol;
processing, by a second client connected to the WebSocket client, responses received from the V8 inspector protocol and translating debugger operations selected by a user into operations known to the V8 inspector; and
executing the source code of the application on the Node.js utilizing launch configuration and data required for starting a Node.js process with responsibilities of terminating the Node.js process when the user ends the debug session.

2. The method as claimed in claim 1, wherein the source code of the application is present in JavaScript format.

3. The method as claimed in claim 1, further comprising allowing debugging on the Node.js under one of inspect and inspect-brk mode.

4. The method as claimed in claim 1, further comprising debugging updates to the source code in a real time by allowing the user to make changes to a script source while being debugged and reflecting the changes in runtime.

5. The method as claimed in claim 1, further comprising providing a sequence of keys as a shortcut to launch debugging of the source code of the application.

6. The method as claimed in claim 1, further comprising providing a stack view showing current stack of execution in the Node.js process, one or more scripts being executed, current function being executed, and a line number of execution within a script.

7. The method as claimed in claim 1, further comprising providing a variable view showing a current state of a script selected by the user.

8. The method as claimed in claim 1, further comprising locating source code of a file being debugged on the Node.js.

9. A system for debugging source code of an application, the system comprising:
a memory; and
a processor coupled to the memory, wherein the processor is capable of executing instructions to perform steps of:
establishing a WebSocket connection with a Chrome DevTools Protocol, using a unique Uniform Resource Locator (URL) created by Node.js, wherein the Chrome DevTools Protocol is a V8 inspector;
listening for asynchronous messages from the V8 inspector, wherein the asynchronous messages are defined by V8 inspector protocol;
processing responses received from the V8 inspector protocol and translating debugger operations selected by a user into operations known to the V8 inspector; and
executing the source code of the application on the Node.js utilizing launch configuration and data required for starting a Node.js process with responsibilities of terminating the Node.js process when the user ends the debug session.

10. The system as claimed in claim 9, wherein the source code of the application is present in JavaScript format.

11. The system as claimed in claim 9, further comprising allowing debugging on the Node.js under one of inspect and inspect-brk mode.

12. The system as claimed in claim 9, further comprising debugging updates to the source code in a real time by allowing the user to make changes to a script source while being debugged and reflecting the changes in runtime.

13. The system as claimed in claim 9, further comprising providing a sequence of keys as a shortcut to launch debugging of the source code of the application.

14. The system as claimed in claim 9, further comprising providing a stack view showing current stack of execution in the Node.js process, one or more scripts being executed, current function being executed, and a line number of execution within a script.

15. The system as claimed in claim 9, further comprising providing a variable view showing a current state of a script selected by the user.

16. The system as claimed in claim 9, further comprising locating source code of a file being debugged on the Node.js.

17. A non-transitory computer program product having embodied thereon a computer program for debugging source code of an application, the computer program product storing instructions for:
establishing a WebSocket connection with a Chrome DevTools Protocol, using a unique Uniform Resource Locator (URL) created by Node.js, wherein the Chrome DevTools Protocol is a V8 inspector;
listening for asynchronous messages from the V8 inspector, wherein the asynchronous messages are defined by V8 inspector protocol;
processing responses received from the V8 inspector protocol and translating debugger operations selected by a user into operations known to the V8 inspector; and
executing the source code of the application on the Node.js utilizing launch configuration and data required for starting a Node.js process with responsibilities of terminating the Node.js process when the user ends the debug session.
